(19) United States
(12) Patent Application Publication
(10) Pub. No.: US 2025/0231871 A1
(43) Pub. Date: Jul. 17, 2025

(54) ADDRESS ERROR CHECKING USING COUNTERS

(71) Applicant: Micron Technology, Inc., Boise, ID (US)

(72) Inventors: Crescenzo Attanasio, Acerra (IT); Paolo Papa, Grumo Nevano (IT); Carminantonio Manganelli, Battipaglia (IT); Massimo Iaculo, San Marco Evangelista (IT)

(21) Appl. No.: 19/015,423

(22) Filed: Jan. 9, 2025

Related U.S. Application Data
(60) Provisional application No. 63/620,084, filed on Jan. 11, 2024.

(51) Int. Cl. G06F 12/02

(52) U.S. Cl. CPC G06F 12/0246; G06F 2212/7201

(57) ABSTRACT

Methods, systems, and devices for address error checking using counters are described. A memory system may verify the validity of portions of a mapping table. During an access operation, the memory system may transfer a portion of the mapping table to a volatile memory and may maintain a copy of the portion in non-volatile memory. The memory system may implement a counter for each portion of the mapping table in the volatile memory and the non-volatile memory. The memory system may compare a value of the counter associated with the portion of the mapping table stored to the volatile memory with a value of the counter associated with the portion of the mapping table stored to the non-volatile memory. If the values match, the portion may be considered valid and an access operation using the portion in the volatile memory may be permitted.

### CROSS REFERENCE

The present Application for Patent claims the benefit of U.S. Provisional Patent Application No. 63/620,084 by ATTANASIO et al., entitled “ADDRESS ERROR CHECKING USING COUNTERS,” filed Jan. 11, 2024, assigned to the assignee hereof, and expressly incorporated by reference herein.

### TECHNICAL FIELD

The following relates to one or more systems for memory, including address error checking using counters.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports address error checking using counters in accordance with examples as disclosed herein.

FIGS. 2A and 2B show examples of a check operation diagram and an increment operation diagram that support address error checking using counters in accordance with examples as disclosed herein.

FIG. 3 shows an example of a process flow that supports address error checking using counters in accordance with examples as disclosed herein.

FIG. 4 shows a block diagram of a memory system that supports address error checking using counters in accordance with examples as disclosed herein.

FIG. 5 shows a flowchart illustrating a method or methods that support address error checking using counters in accordance with examples as disclosed herein.

### DETAILED DESCRIPTION

Some memory systems may implement a mapping table (e.g., a logical-to-physical (L2P) table) that includes mappings between logical addresses and physical addresses of the memory system. The mapping table may be accessed, based on receiving an access command (e.g., during an access operation), to determine a physical address corresponding to a logical address indicated in the access command. In some cases, a memory system may store the mapping table in non-volatile memory (e.g., a NAND array) of the memory system then transfer (e.g., load) a portion of the mapping table (e.g., a physical page table (PPT)) from the non-volatile memory to a volatile memory (e.g., an SRAM array) of the memory system. For example, accessing the portion of the mapping table stored to the volatile memory may be associated with relatively lower latency than accessing the mapping table (e.g., the entirety of the mapping table) stored to the non-volatile memory.

However, in some cases, an invalid portion (e.g., a relatively old portion, an outdated portion) of the mapping table may be transferred to the volatile memory for performing the access operation. In some such cases, the invalid portion of the mapping table may include invalid mappings (e.g., relatively old mappings, outdated mappings) between logical addresses and physical addresses of the memory system. Using an invalid mapping for performing the access operation may result in accessing an incorrect physical address, which may result in incorrect data (e.g., obsolete data, invalid data) being accessed. For example, performing a read operation using an invalid portion of the mapping table may cause the memory system to read data other than the data requested by a corresponding read command. Thus, a memory system configured to verify the validity of portions of the mapping table (e.g., stored to the SRAM) may be desirable.

In accordance with examples as described herein, a memory system may be configured to verify the validity of portions of a mapping table (e.g., stored to volatile memory) for performing access operations. For example, the memory system may implement an operation or procedure (e.g., a check) to determine whether a portion of the mapping table transferred to a volatile memory of the memory system is a valid portion (e.g., a current portion, an up-to-date portion) of the mapping table. In some such examples, the memory system may implement a counter for each portion of the mapping table, and the counter may be updated (e.g., incremented) each time the respective portion of the mapping table is transferred from the volatile memory to a non-volatile memory of the memory system.

In some cases, the non-volatile memory may maintain a copy of each portion of the mapping table and the respective counter when a respective portion of the mapping table is transferred to the volatile memory. Thus, the counters may be used to perform the check, such that each time a portion of the mapping table is transferred to the volatile memory, the memory system may compare the counter associated with the transferred portion to the counter associated with the corresponding portion maintained in the non-volatile memory. If the counters match, the portion may be considered valid and an access operation using the portion of the mapping table stored to the volatile memory may be used for associated access operations. However, if the counters do not match, the portion may be considered invalid and the access operation may be prohibited until the memory system is reset (e.g., until the correct version of the mapping table is transferred to the volatile memory). Implementing a method for verifying the validity of portions of the mapping table for performing access operations may ensure correct data is accessed with relatively low latency.

In addition to applicability in memory systems described herein, techniques for address error checking using counters may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by verifying the validity of mappings used for performing access operations, which may ensure the correct data is accessed with relatively low latency during performing such access operations, among other benefits.

Features of the disclosure are illustrated and described in the context of systems, devices, and circuits. Features of the disclosure are further illustrated and described in the context of a check operation diagram, an increment operation diagram, a process flow, a block diagram, and a flowchart.

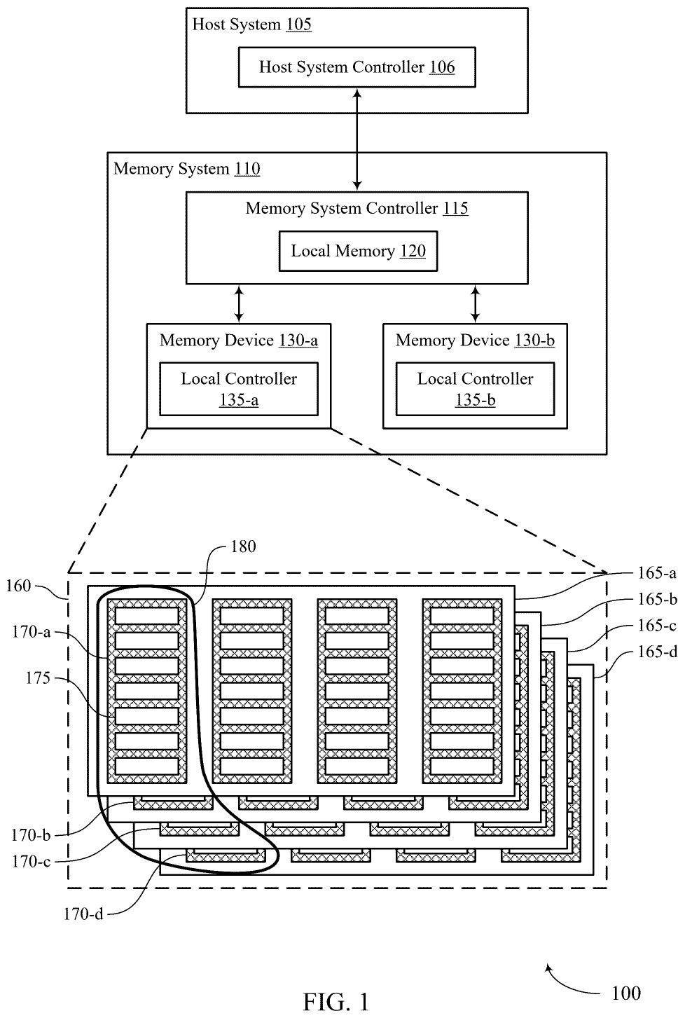

FIG. 1 shows an example of a system 100 that supports address error checking using counters in accordance with examples as disclosed herein. The system 100 includes a host system 105 coupled with a memory system 110. The system 100 may be included in a computing device such as a desktop computer, a laptop computer, a network server, a mobile device, a vehicle (e.g., automobile, train, or other conveyance), an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has not been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support address error checking using counters. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In accordance with examples as described herein, the memory system 110 may be configured to verify the validity of portions of the L2P mapping table (e.g., stored to volatile memory) for performing access operations. For example, the memory system may implement an operation or procedure (e.g., a check) to determine whether a portion of the L2P mapping table transferred to a volatile memory (e.g., a memory device 130) of the memory system 110 is a valid portion (e.g., a current portion, an up-to-date portion) of the L2P mapping table. In some such examples, the memory system 110 may implement a counter for each portion of the L2P mapping table, and the counter may be updated (e.g., incremented) each time the respective portion of the L2P mapping table is transferred from the volatile memory to a non-volatile memory (e.g., a memory device 130) of the memory system 110.

In some cases, the non-volatile memory may maintain a copy of each portion of the L2P mapping table and the respective counter when a respective portion of the L2P mapping table is transferred to the volatile memory. Thus, the counters may be used to perform the check, such that each time a portion of the L2P mapping table is transferred to the volatile memory, the memory system 110 may compare the counter associated with the transferred portion to the counter associated with the corresponding portion maintained in the non-volatile memory. If the counters match, the portion may be considered valid and an access operation using the portion of the L2P mapping table stored to the volatile memory may be used for associated access operations. However, if the counters do not match, the portion may be considered invalid and the access operation may be prohibited until the memory system 110 is reset (e.g., until the correct version of the mapping table is transferred to the volatile memory). Implementing a method for verifying the validity of portions of the L2P mapping table for performing access operations may ensure correct data is accessed with relatively low latency.

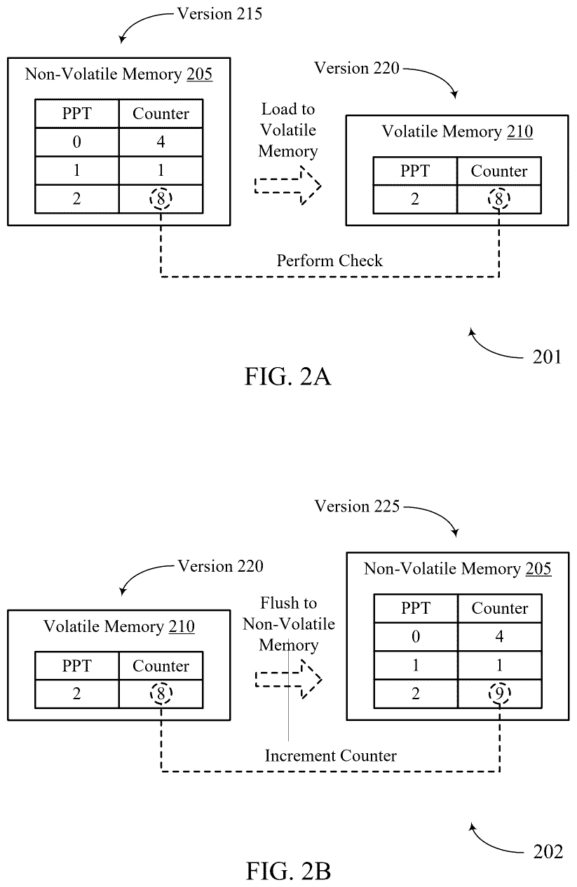

FIGS. 2A and 2B show examples of a block diagram 201 that illustrates a portion of a check operation and a block diagram 202 that illustrates a portion of an increment operation. Both block diagrams 201 and 202 support address error checking using counters in accordance with examples as disclosed herein. The block diagram 201 and the block diagram 202 may illustrate aspects or operations of a system, which may be an example of a system 100, as described with reference to FIG. 1. For example, the block diagram 201 and the block diagram 202 illustrate a non-volatile memory 205 and a volatile memory 210, which may be implemented at a memory system, which may be an example of a memory system 110. In some cases, operations of the memory system may be facilitated by one or more controllers, one or more processors, or processing circuitry, which may be an example of a memory system controller 115. In some cases, operations of the memory system may be facilitated by code including instructions executable by the one or more processors. The block diagram 201 and the block diagram 202 illustrate operations that support verifying the validity of portions of a mapping table for performing access operations, which may ensure correct data is accessed with relatively low latency.

The block diagram 201 and the block diagram 202 illustrate operations of a memory system, which may include the non-volatile memory 205 and the volatile memory 210. The non-volatile memory 205 may be an example of a memory device 130, or may be an example of a memory array implemented at a memory device 130, as described with reference to FIG. 1. For example, the non-volatile memory 205 may be a non-volatile memory array, such as a NAND array, including a quantity of non-volatile memory cells, which may be examples of NAND cells. Likewise, the volatile memory 210 may be an example of another memory device 130, or may be an example of a memory array implemented at another memory device 130. For example, the volatile memory 210 may be a volatile memory array, such as a DRAM array, including a quantity of volatile memory cells, which may be examples of DRAM cells. In other examples, the volatile memory 210 may be implemented at a controller of the memory system, such that the volatile memory 210 may be an example of local memory 120 at a memory system controller 115, as described with reference to FIG. 1. In some such examples, the volatile memory 210 may be an SRAM array including a quantity of SRAM cells.

The block diagram 201 and the block diagram 202 illustrate portions of a mapping table, which may be a L2P mapping table. For example, the mapping table may include mappings between logical addresses and physical addresses of the non-volatile memory 205. In some cases, the mapping table may be divided into portions (e.g., PPTs), each of which include a subset of the mappings (e.g., a subset of the total mappings of the L2P table). The mappings may be used to perform access operations. For example, a read command indicating a logical address may be received at the memory system, and the mapping table may be accessed to determine the corresponding physical address of the non-volatile memory 205 mapped to the logical address. In some cases, the mapping table may be stored in the non-volatile memory 205. However, accessing the mapping table from the non-volatile memory 205 may be associated with relatively high latency. Thus, one or more portions of the mapping table associated with the access operations may be transferred to the volatile memory 210 (e.g., due to limited storage capacity of the volatile memory 210), because accessing the mapping table from the volatile memory 210 may be associated with relatively low latency.

In some cases, each portion of the mapping table may be associated with a counter, where the counter may track a quantity of times the respective portion of the mapping table has been loaded. For example, the counter may track a quantity of times that the respective portion of the mapping table has been transferred (e.g., flushed) from the volatile memory 210 after performing one or more access operations at the volatile memory 210 using the respective portion of the mapping table. As illustrated, PPT 0 may have a counter value of 4, thus that portion of the mapping table may have been flushed 4 times. In some examples, the counter may be incremented (e.g., increased) each time the respective portion of the mapping table is transferred from the volatile memory 210 to the non-volatile memory 205. In some implementations, the counter may be or may be stored as metadata associated with the respective portion of the mapping table. In other implementations, the counter value may be included as a field associated with the respective portion of the mapping table.

The block diagram 201 illustrates performing an access operation using the mapping table. For example, the mapping table may be initially stored in the non-volatile memory 205. First, the memory system may receive an access command (e.g., a read command) indicating a logical address. Next, the memory system may transfer a portion of the mapping table to the volatile memory 210 based on the portion of the mapping table including a mapping between the logical address (e.g., indicated in the access command) and a physical address of the non-volatile memory 205 corresponding to the logical address. For example, the memory system may determine that PPT 2 includes the mapping between the logical address and the physical address, and the memory system may transfer PPT 2 to the volatile memory 210.

In some cases, transferring the portion of the mapping table from the non-volatile memory 205 to the volatile memory 210 may be referred to as loading the portion of the mapping table. In some examples, the transferred portion of the mapping table may include the counter associated with the portion of the mapping table. In some such examples, a copy of the portion of the mapping table and the counter (e.g., the counter value) associated with the portion of the mapping table may be maintained in the non-volatile memory 205. In some implementations, the portion of the mapping table maintained in the non-volatile memory 205 may be considered a first version 215 of the portion, and the portion of the mapping table transferred to the volatile memory 210 may be considered a second version 220 of the portion.

After transferring the portion of the mapping table to the volatile memory 210, the memory system may perform a check to determine whether the portion of the mapping table in the volatile memory 210 is valid (e.g., current, up-to-date). The memory system may perform the check using the counters associated with the portion of the mapping table. For example, the memory system may compare the counter associated with the portion of the mapping table (e.g., PPT 2) transferred to the volatile memory 210 with the counter associated with the portion of the mapping table (e.g., PPT 2) maintained in the non-volatile memory 205. That is, the memory system may compare the second version 220 of the portion with the first version 215 of the portion.

In some cases, the counters may match (e.g., values of the counters may match), thereby indicating the portion of the mapping table in the volatile memory 210 is valid (e.g., includes valid mappings, includes mappings indicating the correct physical addresses for the corresponding logical addresses). In some such cases, the memory system may perform the access operation using the portion of the mapping table in the volatile memory 210. For example, after transferring PPT 2 to the volatile memory 210, the memory system may perform the check and determine that the counter (e.g., 8) of PPT 2 maintained in the non-volatile memory 205 matches the counter (e.g., 8) of PPT 2 transferred to the volatile memory 210. Then, the memory system may use PPT 2 to identify the mapping between the logical address indicated in the access command and the corresponding physical address.

However, in other cases, the counters may not match (e.g., the values of the counters may not match), thereby indicating the portion of the mapping table in the volatile memory 210 is invalid (e.g., incorrect, out-of-date, includes incorrect mappings, includes mappings indicating incorrect physical addresses for the logical addresses). In some such cases, the memory system may transmit an indication (e.g., to a host system coupled with the memory system) that an error occurred, thus indicating that the access operation could not be performed. In order to perform the same access operation, or another access operation, the memory system may first be reset, such that the respective portion of the mapping table reloaded to the volatile memory 210. In other examples, the respective portion of the mapping table reloaded to the volatile memory 210 without the memory system being reset.

The block diagram 202 illustrates incrementing the counter after performing the access operation using the portion of the mapping table. In cases in which the counters match (e.g., indicating the portion of the mapping table in the volatile memory 210 is valid) and the access operation is performed using the portion of the mapping table, the portion of the mapping table may be maintained in the volatile memory 210 until a trigger condition is identified. In some examples, the trigger condition may include receiving a command to flush the volatile memory 210 (e.g., a command to transfer the portion of the mapping table from the volatile memory 210 to the non-volatile memory 205). In some such examples, the memory system may receive a command from the host system indicating the memory system to erase the volatile memory 210 (e.g., erase the information stored in the volatile memory, including the portion of the mapping table) or transfer information out of the volatile memory 210 (e.g., to the non-volatile memory 205, including the portion of the mapping table). In other examples, the trigger condition may include determining that a quantity of access operations (e.g., write operations) has satisfied a threshold. In some such examples, the memory system may track a quantity of write operations performed on the non-volatile memory 205, and the memory system may perform checks after each write operation is performed to determine whether the quantity of write operations has satisfied a threshold quantity of write operations. In another example, the trigger condition may include determining that a storage capacity of the volatile memory 210 has satisfied a threshold. In some such examples, the volatile memory 210 may have a storage capacity for storing a threshold quantity of information, and the memory system may identify that the quantity of information stored to the volatile memory 210 has reached the storage capacity after loading a quantity of portions of the mapping table (e.g., or other information) into the volatile memory 210. The memory system may identify the trigger condition, and transfer the portion of the mapping table to (e.g., back to) the non-volatile memory 205.

In some cases, transferring the portion of the mapping table may include transferring other portions of the mapping table loaded to the volatile memory 210 since identifying a previous trigger condition. The memory system may increment (e.g., increase) the counter (e.g., the value of the counter increasing from 8 to 9, as illustrated) associated with the portion of the mapping table based on identifying the trigger condition and/or transferring the portion of the mapping table to the non-volatile memory 205. In some cases, transferring the portion of the mapping table from the volatile memory 210 to the non-volatile memory 205 may be referred to as flushing the volatile memory 210. In some cases, transferring the portion of the mapping table may include replacing the portion of the mapping table in the non-volatile memory 205, which may include updating the value of the counter previously stored to the non-volatile memory 205.

Implementing the block diagram 201 and the block diagram 202 may support verifying the validity of portions of a mapping table for performing access operations. In some cases, verifying the validity of a portion of the mapping table may ensure the portion of the mapping table includes a valid mapping (or valid mappings). In some such cases, performing an access operation using a valid mapping may ensure that the physical address accessed during the access operation is the correct physical address. Thus, implementing the block diagram 201 and the block diagram 202 may ensure the correct data is accessed during an access operation, which may improve reliability of the memory system, among other benefits.

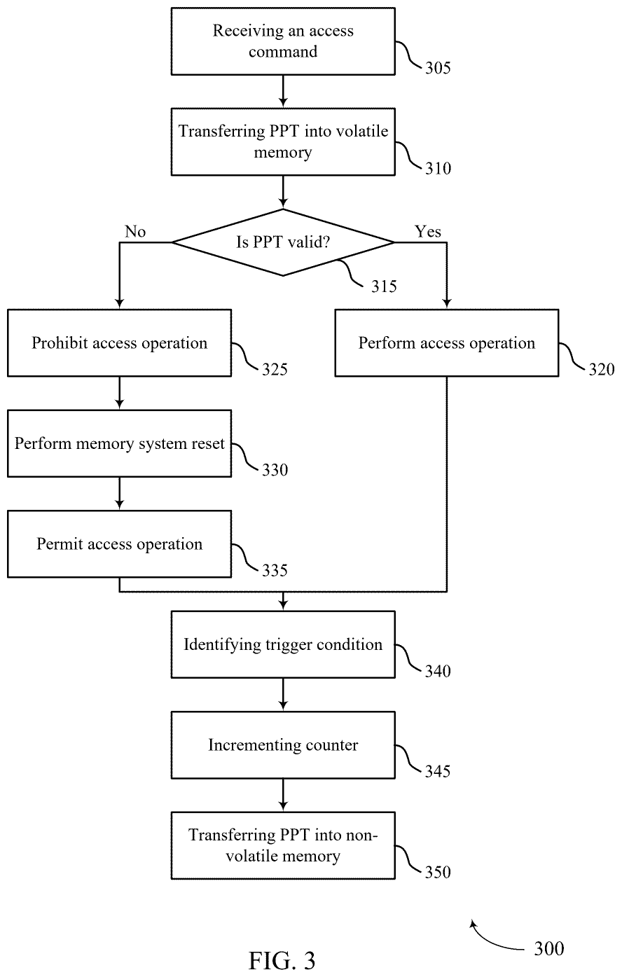

FIG. 3 shows an example of a process flow 300 that supports address error checking using counters in accordance with examples as disclosed herein. The process flow 300 may illustrate aspects or operations of a system, which may be an example of a system 100, as described with reference to FIG. 1. For example, the process flow 300 may be implemented by a host system and/or a memory system, which may be examples of a host system 105 and a memory system 110, respectively. In some cases, the process flow 300 may illustrate aspects or operations illustrated by a block diagram 201 and an block diagram 202, as described with reference to FIGS. 2A and 2B. For example, the process flow 300 may include operations associated with a non-volatile memory and a volatile memory, which may be examples of a non-volatile memory 205 and a volatile memory 210, respectively. In the following description of the process flow 300, the methods, techniques, processes, and operations may be performed in different orders or at different times. Further, some operations may be left out of the process flow 300, or other operations may be added to the process flow 300.

Aspect of the process flow 300 may be implemented by a memory system controller 115 or by the host system 105, as described with reference to FIG. 1. Additionally, or alternatively, aspects of the process flow 300 may be implemented as instructions stored in memory (e.g., firmware). For example, the instructions, if executed by a controller (e.g., a processor, a host system controller 106, the memory system controller 115, a local controller 135), may cause the controller to perform the operations of the process flow 300. The process flow 300 illustrates operations which support verifying the validity of portions of a mapping table for performing access operations, which may ensure correct data is accessed with relatively low latency.

At 305, an access command may be received at the memory system. For example, the host system may transmit an access command to the memory system to initiate an access operation at the memory system. In some cases, the access command may be an example of a read command, and may indicate a logical address to be accessed during the access operation. The logical address may be associated with data stored to a physical address of the non-volatile memory.

At 310, a portion of a mapping table (e.g., a PPT) may be transferred to the volatile memory. The memory system may store (e.g., maintain) the mapping table in the non-volatile memory and identify the portion of the mapping table including a mapping between the logical address and the physical address of the non-volatile memory. The memory system may transfer (e.g., load) the portion of the mapping table from the non-volatile memory to the volatile memory. In some cases, transferring the portion of the mapping table may include transferring a value (e.g., a first value) of a counter associated with the portion of the mapping table to the volatile memory. In some examples, the memory system may maintain a copy of the portion of the mapping table in the non-volatile memory. In some such examples, maintaining the copy of the portion of the mapping table may include maintaining a value (e.g., a second value) of the counter in the non-volatile memory.

At 315, a check may be performed to determine whether the portion of the mapping table in the volatile memory is valid (e.g., current, correct, up-to-date). For example, the memory system may determine whether the value of the counter in the volatile memory matches the value of the counter in the non-volatile memory. In some cases, the values of the counter may match, thereby indicating the portion of the mapping table is valid. In some examples, determining that the values match may verify that the portion of the mapping table in the volatile memory is a valid version of the portion. In some such cases, the process flow 300 may continue to step 320. However, in other cases, the values of the counter may not match, thereby indicating the portion of the mapping table is invalid (e.g., incorrect, out-of-date). In such cases, the process flow 300 may continue to step 325.

At 320, the access operation may be performed. For example, the memory system may perform the access operation based on determining that the portion of the mapping table in the volatile memory is valid. Performing the access operation may include accessing the portion of the mapping table to identify the mapping between the logical address indicated by the access command and the physical address of the non-volatile memory. For example, if the access operation is a read operation, performing the access operation may include reading the data from the physical address of the non-volatile memory based on accessing the portion of the mapping table. In some such examples, performing the access operation may include transmitting the data to the host system. After performing the access operation at 320, the process flow 300 may continue to step 340.

At 325, the access operation may be prohibited. For example, the memory system may prohibit the access operation from being performed based on determining the portion of the mapping table in the volatile memory is invalid. In some cases, the memory system may transmit an indication to the host system that the access operation is prohibited or was otherwise not performed. For example, the memory system may transmit an indication to the host system that the access operation could not be performed due to the associated PPT being out-of-date.

At 330, the memory system may be reset. For example, the memory system or the host system may perform a reset operation of the memory system, in which the volatile memory may be flushed (e.g., information stored in the volatile memory is transferred from the volatile memory to the non-volatile memory, information stored in the volatile memory is erased). In other instances, the volatile memory may be flushed without the memory system being reset.

At 335, access operations may be permitted. For example, the memory system may permit access operations on the non-volatile memory based on resetting the memory system or otherwise flushing the volatile memory. In some cases, the memory system may receive another access command (e.g., a read command) indicating another logical address (e.g., or the same logical address as in the prior access command), and the memory system may transfer another portion (e.g., or the same portion) of the mapping table to the volatile memory. Further, the memory system may perform another check to determine whether the portion of the mapping table is valid, and may perform the access operation based on determining the portion of the mapping table is valid. Otherwise, the memory system may prohibit access operations and perform another reset operation if the portion of the mapping table is identified as invalid.

At 340, a trigger condition may be identified. For example, the memory system may identify the trigger condition after performing the access operation or after permitting access operations. In some examples, the trigger condition may include receiving a command to flush the volatile memory (e.g., a command to transfer the portion of the mapping table from the volatile memory to the non-volatile memory). In other examples, the trigger condition may include determining that a quantity of access operations (e.g., write operations) has satisfied a threshold. In another example, the trigger condition may include determining that a storage capacity of the volatile memory has satisfied a threshold.

At 345, the counter associated with the portion of the mapping table in the volatile memory may be incremented. For example, the memory system may increment the counter based on identifying the trigger condition. In some cases, incrementing the counter may include increasing a value of the counter.

At 350, the portion of the mapping table may be transferred back to the non-volatile memory. For example, the memory system may transfer the portion of the mapping table from the volatile memory to the non-volatile memory based on identifying the trigger condition. In some cases, the transferring the portion of the mapping table to the non-volatile memory may include updating metadata associated with the portion of the mapping table.

Implementing the process flow 300 may support verifying the validity of portions of a mapping table for performing access operations. In some cases, verifying the validity of a portion of the mapping table may ensure the portion of the mapping table includes a valid mapping. In some such cases, performing an access operation using a valid mapping may ensure that the physical address accessed during the access operation is the correct physical address. Thus, implementing the process flow 300 may ensure the correct data is accessed during an access operation, which may improve reliability of the memory system, among other benefits.

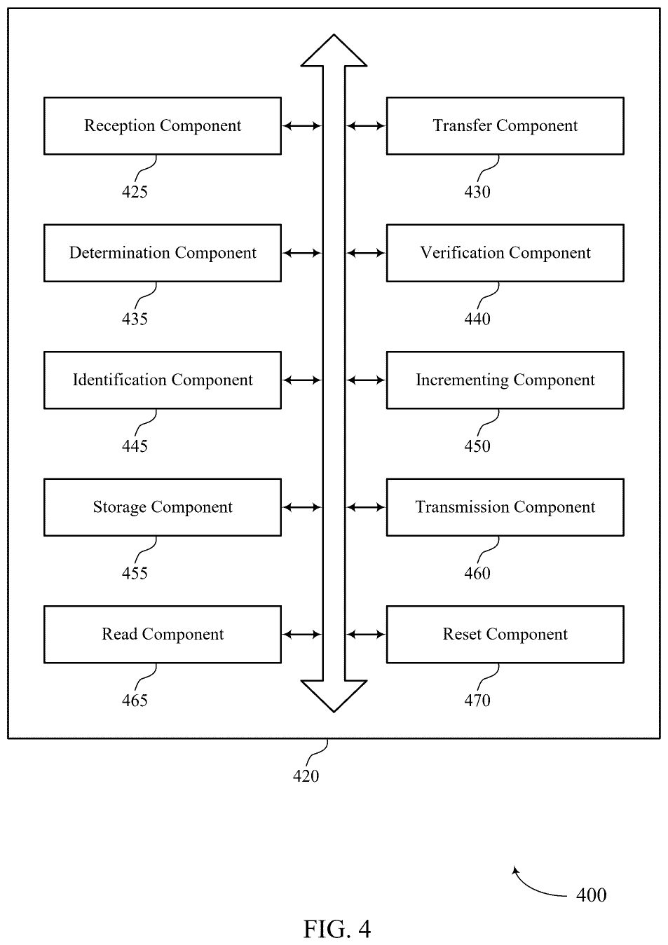

FIG. 4 shows a block diagram 400 of a memory system 420 that supports address error checking using counters in accordance with examples as disclosed herein. The memory system 420 may be an example of aspects of a memory system as described with reference to FIGS. 1 through 3. The memory system 420, or various components thereof, may be an example of means for performing various aspects of address error checking using counters as described herein. For example, the memory system 420 may include a reception component 425, a transfer component 430, a determination component 435, a verification component 440, an identification component 445, an incrementing component 450, a storage component 455, a transmission component 460, a read component 465, a reset component 470, or any combination thereof. Each of these components, or components of subcomponents thereof (e.g., one or more processors, one or more memories), may communicate, directly or indirectly, with one another (e.g., via one or more buses).

The reception component 425 may be configured as or otherwise support a means for receiving a read command including a logical address that is associated with data stored to a physical address of a non-volatile memory array of the memory system. The transfer component 430 may be configured as or otherwise support a means for transferring, from the non-volatile memory array to a volatile memory array of the memory system, a first portion of an address mapping based at least in part on receiving the read command, where the first portion of the address mapping is associated with a counter and includes a mapping between the logical address of the read command and the physical address of the non-volatile memory array. The determination component 435 may be configured as or otherwise support a means for determining whether a first value of the counter matches a second value that is stored to the non-volatile memory array of the memory system based at least in part on transferring the first portion of the address mapping from the non-volatile memory array to the volatile memory array. The verification component 440 may be configured as or otherwise support a means for verifying that the first portion of the address mapping includes a first version based at least in part on determining that the first value matches the second value.

In some examples, the identification component 445 may be configured as or otherwise support a means for identifying a trigger condition for storing the transferred first portion of the address mapping to a portion of the non-volatile memory array. In some examples, the incrementing component 450 may be configured as or otherwise support a means for incrementing the counter to a third value based at least in part on identifying the trigger condition. In some examples, the storage component 455 may be configured as or otherwise support a means for storing the first portion of the address mapping to the portion of the non-volatile memory array based at least in part on incrementing the counter to the third value.

In some examples, the trigger condition includes receiving a flush command, determining that a quantity of write operations has satisfied a first threshold, determining that a storage capacity of a volatile memory of the memory system has satisfied a second threshold, or any combination thereof.

In some examples, the transmission component 460 may be configured as or otherwise support a means for transmitting an indication to a host system that the read command was not satisfied based at least in part on determining that the first value is different than the second value.

In some examples, the reset component 470 may be configured as or otherwise support a means for performing a reset of the memory system based at least in part on transmitting the indication to the host system. In some examples, the transfer component 430 may be configured as or otherwise support a means for transferring, for a second time, the first portion of an address mapping from the non-volatile memory array to the volatile memory array based at least in part on performing the reset of the memory system.

In some examples, the reception component 425 may be configured as or otherwise support a means for receiving a second read command including the logical address that is associated with data stored to the physical address of the non-volatile memory array of the memory system. In some examples, the determination component 435 may be configured as or otherwise support a means for determining that first value of the counter matches the second value based at least in part on receiving the second read command and transferring the first portion of the address mapping from the non-volatile memory array to the volatile memory array for the second time. In some examples, the transmission component 460 may be configured as or otherwise support a means for transmitting the data to the host system based at least in part on determining that the first value of the counter matches the second value.

In some examples, the read component 465 may be configured as or otherwise support a means for reading the data from the physical address of the non-volatile memory array corresponding to the logical address based at least in part on determining that the first value of the counter matches the second value.

In some examples, to support determining whether the first value matches the second value, the determination component 435 may be configured as or otherwise support a means for comparing the first value of the counter with the second value, where the second value is associated with a version of the first portion of the address mapping.

In some examples, the first value is indicated by metadata associated with a set of mappings included in the first portion of the address mapping. In some examples, the set of mappings includes the logical address and the physical address.

In some examples, the first value is indicated by a field associated with the first portion of the address mapping.

In some examples, the first portion of the address mapping includes a second version based at least in part on the first value being different than the second value.

In some examples, the first version includes an up-to-date version of the first portion of the address mapping and the second version includes an out-of-date version of the first portion of the address mapping.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

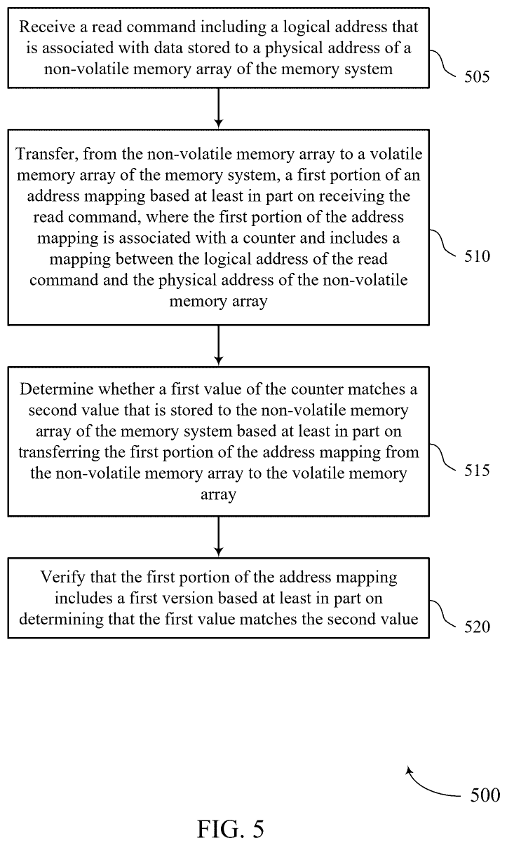

FIG. 5 shows a flowchart illustrating a method 500 that supports address error checking using counters in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving a read command including a logical address that is associated with data stored to a physical address of a non-volatile memory array of the memory system. In some examples, aspects of the operations of 505 may be performed by a reception component 425 as described with reference to FIG. 4.

At 510, the method may include transferring, from the non-volatile memory array to a volatile memory array of the memory system, a first portion of an address mapping based at least in part on receiving the read command, where the first portion of the address mapping is associated with a counter and includes a mapping between the logical address of the read command and the physical address of the non-volatile memory array. In some examples, aspects of the operations of 510 may be performed by a transfer component 430 as described with reference to FIG. 4.

At 515, the method may include determining whether a first value of the counter matches a second value that is stored to the non-volatile memory array of the memory system based at least in part on transferring the first portion of the address mapping from the non-volatile memory array to the volatile memory array. In some examples, aspects of the operations of 515 may be performed by a determination component 435 as described with reference to FIG. 4.

At 520, the method may include verifying that the first portion of the address mapping includes a first version based at least in part on determining that the first value matches the second value. In some examples, aspects of the operations of 520 may be performed by a verification component 440 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a read command including a logical address that is associated with data stored to a physical address of a non-volatile memory array of the memory system; transferring, from the non-volatile memory array to a volatile memory array of the memory system, a first portion of an address mapping based at least in part on receiving the read command, where the first portion of the address mapping is associated with a counter and includes a mapping between the logical address of the read command and the physical address of the non-volatile memory array; determining whether a first value of the counter matches a second value that is stored to the non-volatile memory array of the memory system based at least in part on transferring the first portion of the address mapping from the non-volatile memory array to the volatile memory array; and verifying that the first portion of the address mapping includes a first version based at least in part on determining that the first value matches the second value.

Aspect 2: The method, apparatus, or non-transitory computer-readable medium of aspect 1, further including operations, features, circuitry, logic, means, or instructions, or any combination thereof for identifying a trigger condition for storing the transferred first portion of the address mapping to a portion of the non-volatile memory array; incrementing the counter to a third value based at least in part on identifying the trigger condition; and storing the first portion of the address mapping to the portion of the non-volatile memory array based at least in part on incrementing the counter to the third value.

Aspect 3: The method, apparatus, or non-transitory computer-readable medium of aspect 2, where the trigger condition includes receiving a flush command, determining that a quantity of write operations has satisfied a first threshold, determining that a storage capacity of a volatile memory of the memory system has satisfied a second threshold, or any combination thereof.

Aspect 4: The method, apparatus, or non-transitory computer-readable medium of any of aspects 1 through 3, further including operations, features, circuitry, logic, means, or instructions, or any combination thereof for transmitting an indication to a host system that the read command was not satisfied based at least in part on determining that the first value is different than the second value.

Aspect 5: The method, apparatus, or non-transitory computer-readable medium of aspect 4, further including operations, features, circuitry, logic, means, or instructions, or any combination thereof for performing a reset of the memory system based at least in part on transmitting the indication to the host system and transferring, for a second time, the first portion of an address mapping from the non-volatile memory array to the volatile memory array based at least in part on performing the reset of the memory system.

Aspect 6: The method, apparatus, or non-transitory computer-readable medium of aspect 5, further including operations, features, circuitry, logic, means, or instructions, or any combination thereof for receiving a second read command including the logical address that is associated with data stored to the physical address of the non-volatile memory array of the memory system; determining that first value of the counter matches the second value based at least in part on receiving the second read command and transferring the first portion of the address mapping from the non-volatile memory array to the volatile memory array for the second time; and transmitting the data to the host system based at least in part on determining that the first value of the counter matches the second value.

Aspect 7: The method, apparatus, or non-transitory computer-readable medium of any of aspects 1 through 6, further including operations, features, circuitry, logic, means, or instructions, or any combination thereof for reading the data from the physical address of the non-volatile memory array corresponding to the logical address based at least in part on determining that the first value of the counter matches the second value.

Aspect 8: The method, apparatus, or non-transitory computer-readable medium of any of aspects 1 through 7, where determining whether the first value matches the second value includes operations, features, circuitry, logic, means, or instructions, or any combination thereof for comparing the first value of the counter with the second value, where the second value is associated with a version of the first portion of the address mapping.

Aspect 9: The method, apparatus, or non-transitory computer-readable medium of any of aspects 1 through 8, where the first value is indicated by metadata associated with a set of mappings included in the first portion of the address mapping and the set of mappings includes the logical address and the physical address.

Aspect 10: The method, apparatus, or non-transitory computer-readable medium of any of aspects 1 through 9, where the first value is indicated by a field associated with the first portion of the address mapping.

Aspect 11: The method, apparatus, or non-transitory computer-readable medium of any of aspects 1 through 10, where the first portion of the address mapping includes a second version based at least in part on the first value being different than the second value.

Aspect 12: The method, apparatus, or non-transitory computer-readable medium of aspect 11, where the first version includes an up-to-date version of the first portion of the address mapping and the second version includes an out-of-date version of the first portion of the address mapping.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a read command comprising a logical address that is associated with data stored to a physical address of a non-volatile memory array of the memory system;
transfer, from the non-volatile memory array to a volatile memory array of the memory system, a first portion of an address mapping based at least in part on receiving the read command, wherein the first portion of the address mapping is associated with a counter and includes a mapping between the logical address of the read command and the physical address of the non-volatile memory array;
determine whether a first value of the counter matches a second value that is stored to the non-volatile memory array of the memory system based at least in part on transferring the first portion of the address mapping from the non-volatile memory array to the volatile memory array; and
verify that the first portion of the address mapping comprises a first version based at least in part on determining that the first value matches the second value.

2. The memory system of claim 1, wherein the processing circuitry is further configured to cause the memory system to:
identify a trigger condition for storing the transferred first portion of the address mapping to a portion of the non-volatile memory array;
increment the counter to a third value based at least in part on identifying the trigger condition; and
store the first portion of the address mapping to the portion of the non-volatile memory array based at least in part on incrementing the counter to the third value.

3. The memory system of claim 2, wherein the trigger condition comprises receiving a flush command, determining that a quantity of write operations has satisfied a first threshold, determining that a storage capacity of a volatile memory of the memory system has satisfied a second threshold, or any combination thereof.

4. The memory system of claim 1, wherein the processing circuitry is further configured to cause the memory system to:
transmit an indication to a host system that the read command was not satisfied based at least in part on determining that the first value is different than the second value.

5. The memory system of claim 4, wherein the processing circuitry is further configured to cause the memory system to:
perform a reset of the memory system based at least in part on transmitting the indication to the host system; and
transfer, for a second time, the first portion of an address mapping from the non-volatile memory array to the volatile memory array based at least in part on performing the reset of the memory system.

6. The memory system of claim 5, wherein the processing circuitry is further configured to cause the memory system to:
receive a second read command comprising the logical address that is associated with data stored to the physical address of the non-volatile memory array of the memory system;
determine that first value of the counter matches the second value based at least in part on receiving the second read command and transferring the first portion of the address mapping from the non-volatile memory array to the volatile memory array for the second time; and
transmit the data to the host system based at least in part on determining that the first value of the counter matches the second value.

7. The memory system of claim 1, wherein the processing circuitry is further configured to cause the memory system to:
read the data from the physical address of the non-volatile memory array corresponding to the logical address based at least in part on determining that the first value of the counter matches the second value.

8. The memory system of claim 1, wherein determining whether the first value matches the second value comprises the processing circuitry configured to cause the memory system to:
compare the first value of the counter with the second value, wherein the second value is associated with a version of the first portion of the address mapping.

9. The memory system of claim 1, wherein:
the first value is indicated by metadata associated with a set of mappings included in the first portion of the address mapping, and
the set of mappings comprises the logical address and the physical address.

10. The memory system of claim 1, wherein the first value is indicated by a field associated with the first portion of the address mapping.

11. The memory system of claim 1, wherein the first portion of the address mapping comprises a second version based at least in part on the first value being different than the second value.

12. The memory system of claim 11, wherein the first version comprises an up-to-date version of the first portion of the address mapping and the second version comprises an out-of-date version of the first portion of the address mapping.

13. A non-transitory computer-readable medium storing code, the code comprising instructions executable by one or more processors to:
receive a read command comprising a logical address that is associated with data stored to a physical address of a non-volatile memory array of a memory system;
transfer, from the non-volatile memory array to a volatile memory array of the memory system, a first portion of an address mapping based at least in part on receiving the read command, wherein the first portion of the address mapping is associated with a counter and includes a mapping between the logical address of the read command and the physical address of the non-volatile memory array;
determine whether a first value of the counter matches a second value that is stored to the non-volatile memory array of the memory system based at least in part on transferring the first portion of the address mapping from the non-volatile memory array to the volatile memory array; and
verify that the first portion of the address mapping comprises a first version based at least in part on determining that the first value matches the second value.

14. The non-transitory computer-readable medium of claim 13, wherein the instructions are further executable by the one or more processors to:
identify a trigger condition for storing the transferred first portion of the address mapping to a portion of the non-volatile memory array;
increment the counter to a third value based at least in part on identifying the trigger condition; and
store the first portion of the address mapping to the portion of the non-volatile memory array based at least in part on incrementing the counter to the third value.

15. The non-transitory computer-readable medium of claim 14, wherein the trigger condition comprises receiving a flush command, determining that a quantity of write operations has satisfied a first threshold, determining that a storage capacity of a volatile memory of the memory system has satisfied a second threshold, or any combination thereof.

16. The non-transitory computer-readable medium of claim 13, wherein the instructions are further executable by the one or more processors to:
transmit an indication to a host system that the read command was not satisfied based at least in part on determining that the first value is different than the second value.

17. The non-transitory computer-readable medium of claim 16, wherein the instructions are further executable by the one or more processors to:
perform a reset of the memory system based at least in part on transmitting the indication to the host system; and
transfer, for a second time, the first portion of an address mapping from the non-volatile memory array to the volatile memory array based at least in part on performing the reset of the memory system.

18. The non-transitory computer-readable medium of claim 17, wherein the instructions are further executable by the one or more processors to:
receive a second read command comprising the logical address that is associated with data stored to the physical address of the non-volatile memory array of the memory system;
determine that first value of the counter matches the second value based at least in part on receiving the second read command and transferring the first portion of the address mapping from the non-volatile memory array to the volatile memory array for the second time; and
transmit the data to the host system based at least in part on determining that the first value of the counter matches the second value.

19. The non-transitory computer-readable medium of claim 13, wherein the instructions are further executable by the one or more processors to:
read the data from the physical address of the non-volatile memory array corresponding to the logical address based at least in part on determining that the first value of the counter matches the second value.

20. The non-transitory computer-readable medium of claim 13, wherein the instructions to determine whether the first value matches the second value are executable by the one or more processors to:
compare the first value of the counter with the second value, wherein the second value is associated with a version of the first portion of the address mapping.

21. The non-transitory computer-readable medium of claim 13, wherein:
the first value is indicated by metadata associated with a set of mappings included in the first portion of the address mapping, and
the set of mappings comprises the logical address and the physical address.

22. The non-transitory computer-readable medium of claim 13, wherein the first value is indicated by a field associated with the first portion of the address mapping.

23. The non-transitory computer-readable medium of claim 13, wherein the first portion of the address mapping comprises a second version based at least in part on the first value being different than the second value.

24. A method by a memory system, comprising:
receiving a read command comprising a logical address that is associated with data stored to a physical address of a non-volatile memory array of the memory system;
transferring, from the non-volatile memory array to a volatile memory array of the memory system, a first portion of an address mapping based at least in part on receiving the read command, wherein the first portion of the address mapping is associated with a counter and includes a mapping between the logical address of the read command and the physical address of the non-volatile memory array;
determining whether a first value of the counter matches a second value that is stored to the non-volatile memory array of the memory system based at least in part on transferring the first portion of the address mapping from the non-volatile memory array to the volatile memory array; and
verifying that the first portion of the address mapping comprises a first version based at least in part on determining that the first value matches the second value.

25. The method of claim 24, further comprising:
identifying a trigger condition for storing the transferred first portion of the address mapping to a portion of the non-volatile memory array;
incrementing the counter to a third value based at least in part on identifying the trigger condition; and
storing the first portion of the address mapping to the portion of the non-volatile memory array based at least in part on incrementing the counter to the third value.
